(19) United States
(12) Patent Application Publication
(10) Pub. No.: US 2024/0217737 A1
(43) Pub. Date: Jul. 4, 2024

(54) PACK AND EJECT SYSTEM FOR REFUSE VEHICLE

(71) Applicant: Oshkosh Corporation, Oshkosh, WI (US)

(72) Inventors: Vince Schad, Oshkosh, WI (US); Erik Ellifson, Oshkosh, WI (US); Eric Braun, Oshkosh, WI (US); Brady Slaughter, Oshkosh, WI (US); Patrick Dillman, Hartford, WI (US); Ryan Ullius, Oshkosh, WI (US); Jeremy Kiekhaefer, Oshkosh, WI (US); Martin J. Schimke, Red Granite, WI (US); Caleb Binder, Oshkosh, WI (US); Bennett Unfried, Oshkosh, WI (US); Derek Wente, Austin, MN (US); Jacob Wallin, Oshkosh, WI (US); Matt Erickson, Oshkosh, WI (US)

(21) Appl. No.: 18/399,537

(22) Filed: Dec. 28, 2023

Related U.S. Application Data
(60) Provisional application No. 63/435,964, filed on Dec. 29, 2022.

(51) Int. Cl. B65F 3/20; B65F 3/28

(52) U.S. Cl. CPC B65F 3/201; B65F 3/207; B65F 3/28

(57) ABSTRACT

A refuse vehicle according to the present disclosure includes a chassis, a cab coupled to the chassis, a refuse compartment body coupled to the chassis and defining a hopper and a storage volume; and a packer assembly including a packer body coupled to at least one actuator and disposed at least partially within the refuse compartment body, the packer body movable between at least a portion of the hopper and at least a portion of the storage volume, and an enclosure that extends along the refuse body parallel to the chassis, the enclosure at least partially separating the at least one actuator from the refuse compartment.

### CROSS-REFERENCE TO RELATED PATENT APPLICATIONS

The present application claims the benefit of and priority to U.S. Provisional Patent Application No. 63/435,964, filed Dec. 29, 2022, which is incorporated herein by reference in its entirety for any purpose whatsoever.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

Refuse vehicles may have a hopper for containing the refuse during collection and transport. Refuse may be a mixture of solid and liquid refuse. Liquids may leach from the refuse and mix within the hopper, occupying a portion of the hopper. This leachate may splash during transport of the refuse, coating the interior of the hopper and components of the refuse vehicle with the leachate. The refuse vehicles may be front loading, in which case the refuse is collected near the front end of the vehicle and then is deposited into the hopper, or side loading, in which case refuse is collected alongside of the hopper and/or refuse body and deposited into the hopper. During collection of the refuse, the refuse may accumulate near a location at which refused is deposited into the hopper, reducing the effective capacity of the hopper by causing other portions of the hopper to be underutilized.

### SUMMARY

One embodiment relates to a pack and eject system for use in packing and ejecting refuse from a refuse vehicle. The refuse vehicle includes a chassis, a cab coupled to the chassis, a body coupled to the chassis having a refuse compartment including a hopper for receiving refuse and a storage volume to contain the refuse, an onboard power source (e.g., a battery or a motor), and a pack and eject system. The pack and eject system includes at least one packer member and an actuator coupled to the packer member. The pack and eject system may be fully or partially contained within the hopper or the storage volume of the refuse vehicle. Parts of the pack and eject system may be positioned outside of the storage volume and the hopper so as to prevent ingestion of leachate and/or other materials from the refuse compartment into the pack and eject system. The packer member is coupled to an actuator and may be movable between a plurality of positions. For example, the packer member may be movable between a first ready position, a second packing position, and a third eject position. The packer member may move between the plurality of positions by linear motion or rotation. To improve space utilization of the refuse compartment, the refuse may be packed at various intervals as the refuse accumulates in the refuse compartment by a packing process. An ejection process may be performed to eject the refuse from the refuse compartment.

In at least one embodiment, the pack and eject system includes an enclosure that separates portions of the actuator from the refuse compartment and that is configured to prevent ingestion of refuse and/or other materials into the actuator. The enclosure may be disposed outside of the refuse compartment and at a height above a liquid level of leachate within the refuse compartment. The pack and eject system may also include a scrapper member or another debris removal device that is configured to direct refuse and/or other materials away from the actuator during operation.

In some embodiments, the packer body includes surfaces that are angled to facilitate packing and ejecting the refuse. In one embodiment, the packer body includes at least one sloped surface and at least one surface that is substantially vertical. In some embodiments, the pack and eject system includes at least one ball screw actuator, though additional ball screw actuators may be used as needed based on the expected load. In some embodiments, a first actuator is disposed at least partially along a first side of the refuse compartment body and a second actuator is disposed at least partially along a second opposite side of the refuse compartment body. It is preferred that the actuators be placed to minimize or prevent contact with liquid leachate that may be produced during the packing process. Additionally, protective equipment may be employed to prevent refuse and leachate from interfering with the operation of the actuator.

In another aspect, provided herein is a refuse vehicle including a chassis; a cab coupled to the chassis; a refuse body coupled to the chassis and defining a refuse compartment; and a packer assembly. The packer assembly includes a packer body disposed within the refuse compartment and an actuator coupled to the packer body and configured to move the packer body within the refuse compartment, and an enclosure that extends along the refuse body parallel to the chassis, the enclosure at least partially separating the at least one actuator from the refuse compartment. In some embodiments, the actuator is spaced apart from a lower wall of the refuse body to be above a liquid level of the refuse stream within the refuse compartment. In some embodiments, the at least one actuator is a ball screw actuator. In some embodiments, the ball screw actuator includes a ball screw and a scraper positioned at least partially within a groove of the ball screw to remove refuse from the ball screw during operation of the ball screw actuator.

In some embodiments, the enclosure is disposed outside of the refuse compartment. In some embodiments, the actuator includes a guide shoe disposed within the enclosure and coupled to the packer body, the channel directing movement of the guide shoe along a length of the refuse body. In some embodiments, a sidewall of the refuse body defines an elongated slot that extends in a longitudinal direction along the refuse body, the slot connecting the enclosure to the refuse compartment. In some embodiments, the enclosure defines a longitudinally extending channel, and wherein a height of the slot is less than a height of the channel. In some embodiments, the enclosure is coupled to an outer surface of a sidewall of the refuse body and the enclosure defines a first channel along a first side of the refuse body, and the actuator is disposed within the enclosure.

In some embodiments, the packer body includes at least one sloped surface and at least one surface that is substantially vertical. In some embodiments, the packer body is movable between a first ready position and a second packing position by rotation of the packer body, linear movement of the packer body, or a combination of rotation and linear movement of the packer body. In some embodiments, the packer body is movable between a first ready position and a third eject position by rotation of the packer body, linear movement of the packer body, or a combination of rotation and linear movement of the packer body. In some embodiments, the at least one actuator includes a first actuator and a second actuator, with the first actuator and the second actuator being ball screw actuators.

In another aspect, provided herein is a packer assembly including a packer body configured to be disposed within a refuse compartment of a refuse vehicle; an actuator coupled to the packer body and configured to move the packer body within the refuse compartment; and an enclosure that extends along the refuse body parallel to the chassis, the enclosure at least partially separating the at least one actuator from the refuse compartment.

In some embodiments, the at least one actuator is a ball screw actuator. In some embodiments, the ball screw actuator includes a ball screw and a scraper positioned at least partially within a groove of the ball screw to remove refuse from the ball screw during operation of the ball screw actuator. In some embodiments, the packer body includes at least one sloped surface and at least one surface that is substantially vertical. In some embodiments, the packer body also includes a lateral reinforcement member configured to prevent rotation of the packing member in operation or a cover configured to prevent refuse from falling behind the packing member in operation.

In another aspect, provided herein is a packer body configured to be disposed within a refuse compartment of a refuse vehicle, the packer body including: a first refuse contact surface that is substantially vertical; a second surface congruent with the first surface, the second surface angled with respect to the first surface; and a third surface that is substantially vertical, the third surface congruent with the second surface. In some embodiments, the packer body also includes a lateral reinforcement member configured to prevent rotation of the packing member in operation and a cover configured to prevent refuse from falling behind the packing member in operation.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a refuse vehicle, according to an exemplary embodiment.

FIG. 2 is a side view of a vehicle body of a refuse vehicle that may be used with the refuse vehicle of FIG. 1.

FIG. 3 is a side view of another vehicle body of a refuse vehicle that may be used with refuse vehicle of FIG. 1.

FIG. 4 is a side view of yet another vehicle body of a refuse vehicle that may be used with the refuse vehicle of FIG. 1, with a rear lift gate of the body assembly in an open position.

FIG. 5A is a perspective view of a packer assembly including a packer member, accordingly to an exemplary embodiment.

FIG. 5B is a rear perspective view of the packer member of FIG. 5A, according to an exemplary embodiment.

FIG. 6 is another perspective view of a gear assembly of a packing assembly, according to an exemplary embodiment, showing a simplified rear view of the packer member.

FIG. 7A is a perspective view of a packing assembly, showing the rear of the packer member (simplified) and the actuators in a cutaway view of the refuse compartment, according to an exemplary embodiment.

FIG. 7B is a perspective view of a packing assembly, showing the rear of the packer member (simplified) and the actuators in a cutaway view of the refuse compartment, according to the embodiment of FIG. 7A.

FIG. 7C is a perspective and detail view of the actuators of FIG. 7A.

FIG. 7D is another detail view of the actuators of FIG. 7A.

FIG. 7E is yet another detail view of the actuators of FIG. 7A.

FIG. 7F is a side view of the refuse compartment and actuators FIG. 7A, showing the position of the actuators with respect to the refuse compartment.

FIG. 8A is a side view of a rotating packing assembly, according to an exemplary embodiment, showing the packer member in a ready position.

FIG. 8B is a side view of the rotating packing assembly of FIG. 8A, showing the packer member moving to a packing position.

FIG. 9A is a side view of a slide packing assembly, according to an exemplary embodiment, showing the slide packer in a ready position.

FIG. 9B is a side view of the slide packing assembly of FIG. 9A, showing the slide packer in a packing position.

FIG. 10 is a perspective view of a packing assembly that includes a telescopic chain actuator system, according to an exemplary embodiment.

FIG. 11 is a side view of the telescopic chain actuator system of FIG. 10 in a retracted position.

FIG. 12 is a section view of the telescopic chain actuator system of FIG. 10.

FIG. 13 is a schematic of a telescopic chain actuator system, according to an exemplary embodiment.

FIGS. 14A and 14B are schematic illustrations of a telescopic chain actuator system, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

At least one embodiment of the present disclosure relates to a packing assembly for a refuse vehicle that is configured to improve utilization of space within a vehicle body of the refuse vehicle during loading operations and to assist with ejecting refuse from the vehicle body. The packing assembly may be disposed within the vehicle body, in a hopper portion of the vehicle body that is positioned to receive waste from an external source or in a storage portion of the vehicle body that is configured to store the refuse during transport. Portions of the packing assembly may extend between or be movable between the hopper portion and the storage portion of the vehicle body. Portions of the packing assembly may be alignable with an access door (e.g., top door, side door, rear door, etc.) of the vehicle body, so as to direct and move waste and other material during loading and packing operations.

The packing assembly may include a packing member coupled to at least one actuator. While the packing member may be shown as a solid or hollow block in various figures, the packer member may be a plate, a solid object, a hollow object, or other suitably shaped device. The packing member may be movable between a first ready position, a second packing position, and a third eject position. The packing member may include a main body having at least one angled wall that is configured to receive refuse from a loader assembly of the refuse vehicle and to direct the refuse into an interior compartment of the vehicle body to improve distribution of the waste and/or other material within the interior compartment.

As used herein, the term “hopper” or “hopper portion” refers to a container or a fillable portion of a refuse container, such as an interior compartment of a refuse vehicle body, that is positioned to receive waste and/or other material from an external source, such as a municipal and/or commercial waste receptacle. For example, a hopper may be the portion of a refuse vehicle interior compartment directly below the opening at the top of the compartment for receiving refuse. While the hopper may be discussed in reference to a refuse vehicle, it should be understood that the principles discussed herein could also be applied to other refuse receptacle designs that are not attached to a refuse vehicle. As used herein, the term “packing assembly” refers to a plurality of devices including a packing member and at least one actuator, that functions to improve the distribution of material deposited into the hopper by moving and/or compacting the material into the storage portion of the interior compartment. Similarly, as used herein, the term “packer member” refers to a device or structure that is a portion of the packing assembly that functions to improve the distribution of material deposited into the hopper by moving and/or compacting the material into the storage portion of the interior compartment.

### Packing Member

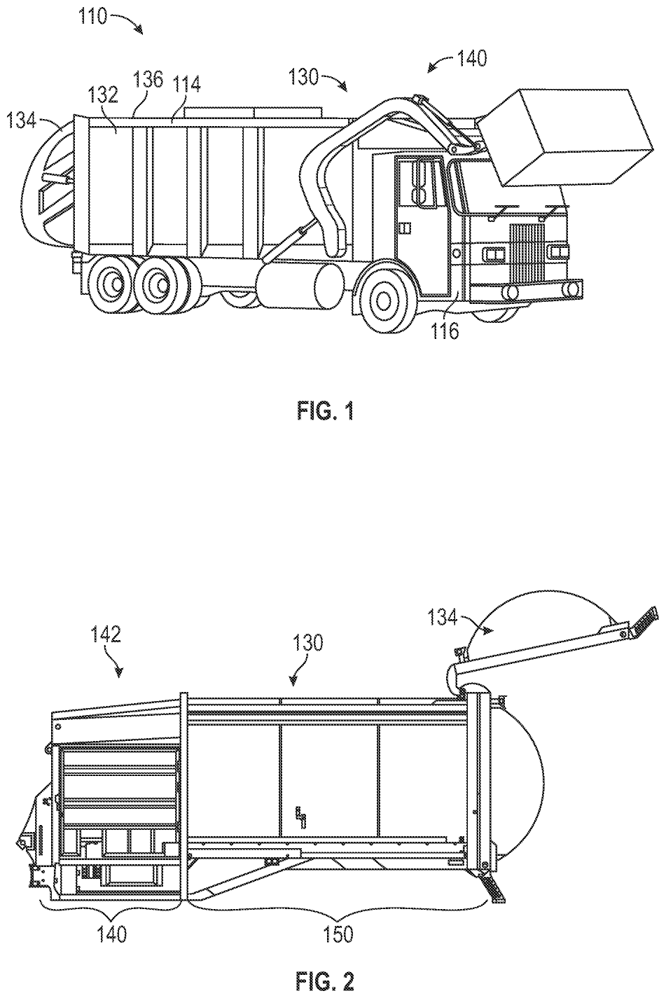

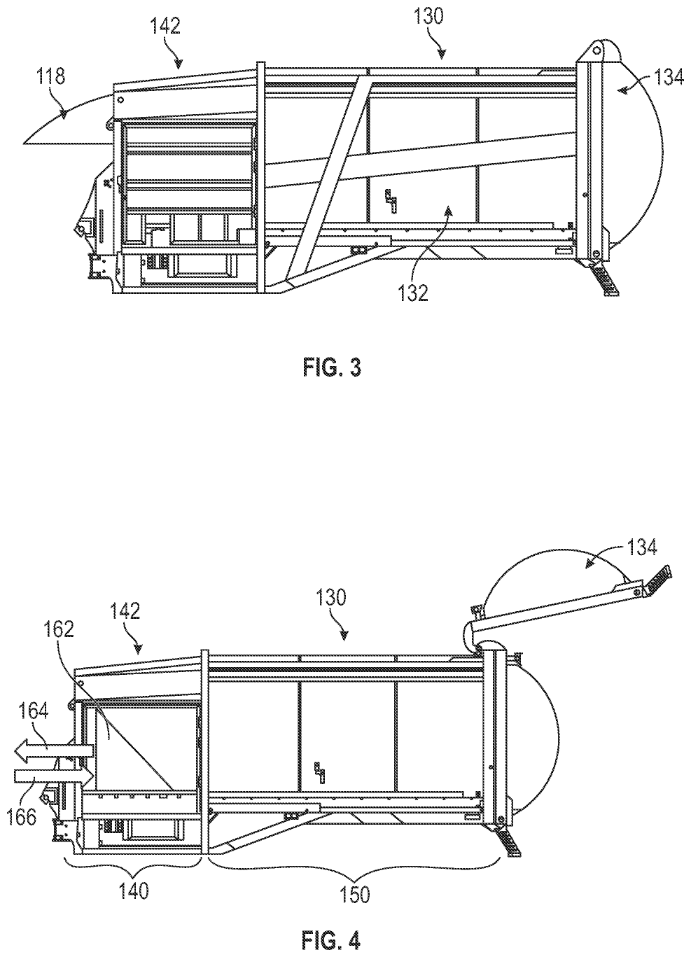

Referring to FIG. 1, a refuse vehicle is shown as vehicle 110. The refuse vehicle 110 is configured to transport refuse from various waste receptacles to a storage and/or processing facility (e.g., a landfill, an incineration facility, a recycling facility, etc.). The refuse vehicle 110 includes a chassis (e.g., a frame, etc.), and a vehicle body (e.g., body assembly, etc.), shown as body 114 coupled to the chassis. The body 114 may be a refuse storage vessel that is configured to receive and store refuse, such as garbage from residential and/or commercial refuse containers. As shown in FIGS. 1-4, the body 114 may include a plurality of panels, shown as panels 132, a tailgate 134, and a cover 136. The panels 132, the tailgate 134, and the cover 136 define a collection chamber (e.g., interior compartment, refuse compartment, waste receptacle, etc.), shown as refuse compartment 130. Loose refuse and/or other material may be placed into the refuse compartment 130 where it may thereafter be compacted (e.g., by a packing system, etc.). The refuse compartment 130 may provide temporary storage for refuse during transport to a waste disposal site and/or a recycling facility. In some embodiments, at least a portion of the body 114 and the refuse compartment 130 extend above or in front of the cab 116. In other embodiments, the space above the cap 118 may house machinery used in the operation of the refuse vehicle. In some embodiments, motors, power sources, and/or gearboxes (not shown) are housed in the volume above the cab 118. According to the embodiment shown in FIG. 1, the body 114 and the refuse compartment 130 are positioned behind the cab 116.

In some embodiments, as in the embodiment in FIG. 2, the refuse compartment 130 includes a hopper volume 140 (or hopper) and a storage volume 150. The hopper 140 may include a hopper aperture 142 for receiving waste. Refuse may be deposited into the hopper 140 and distributed from the hopper 140 into the storage volume 150. Refuse may be initially loaded into the hopper 140 and thereafter compacted into the storage volume 150. According to an exemplary embodiment, the hopper 140 is positioned between the storage volume and the cab 116 (e.g., refuse is loaded into a position of the refuse compartment 130 behind the cab 116 and stored in a position further toward the rear of the refuse compartment 130, a front-loading refuse vehicle, a side-loading refuse vehicle, etc.). In other embodiments, the storage volume may be positioned between the hopper 140 and the cab 116 (e.g., a rear-loading refuse vehicle, etc.).

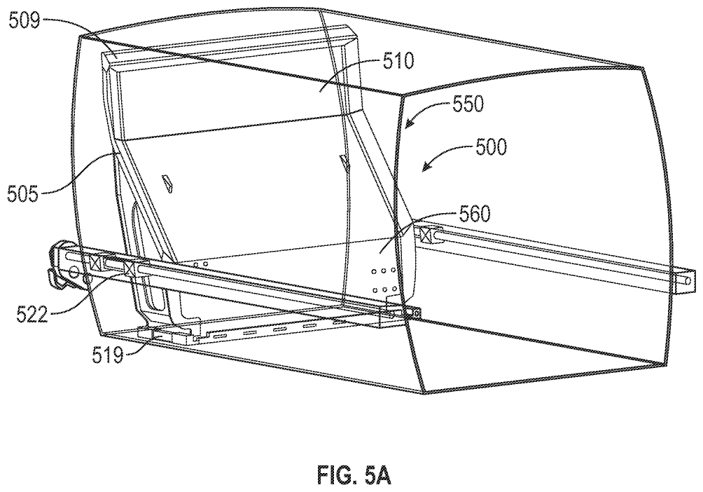

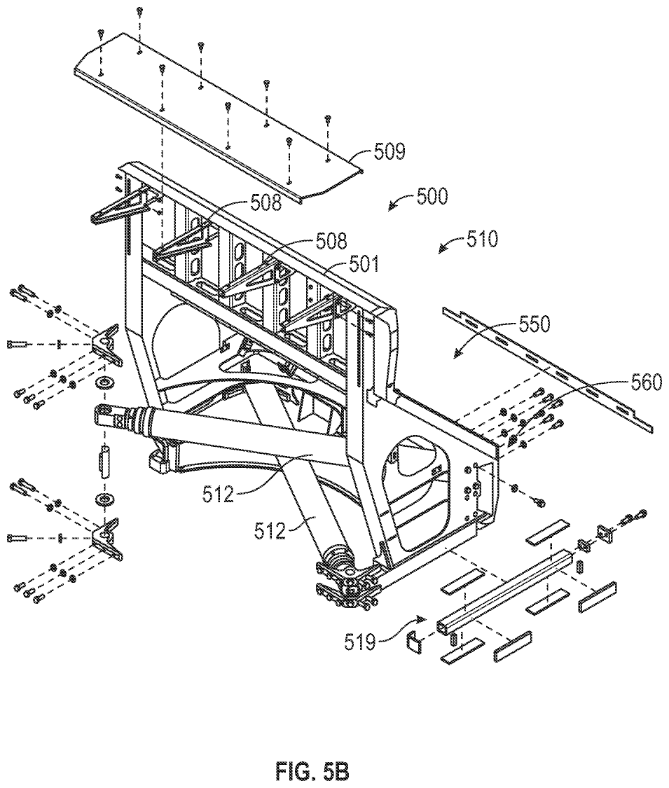

With reference to FIGS. 4 and 5A-5B, according to an exemplary embodiment, a refuse vehicle hopper 140 includes a packing assembly 160, shown as packer member 162. The packer member 162 may be positioned partially or wholly within the hopper 140. Alternatively, or depending upon an operating condition of the refuse vehicle, the packer member 162 may be positioned outside of the hopper 140 (e.g. toward a rear end of the vehicle body during eject operations, as will be further described). The packer member 162 may include at least one sloped upper surface 550 that may function to direct refuse material deposited into the hopper 140 and/or to direct refuse material deposited into the hopper 162 away from the hopper 142 and into the storage volume 150. In one exemplary embodiment, the packer member 162 is positioned near the front end of the refuse compartment 130 and is configured to direct the material deposited into the packer member 162 toward the rear end of the refuse compartment 130. The packer member 162 may made be constructed of one or more materials including high durability plastic or metal.

With continued reference to FIG. 4, the packing assembly may include actuators to move the packer member 162 and/or portions thereof relative to the vehicle body (e.g., into the storage volume 150). In some exemplary embodiments, the packer member 162 may be movable in a first direction 164 (e.g., a longitudinal direction parallel to the vehicle chassis) toward the storage volume 150 of the refuse compartment 130. In some exemplary embodiments, the packer member 162 may be movable in a second direction 166 away from the storage volume 150 of the refuse compartment 130. In some embodiments, the packer member 162 is movable at least partially into the storage volume 150 of the refuse compartment 130. In some embodiments, the packer member 162 is movable fully into the storage volume 150 of the refuse compartment 130.

With continued reference to FIG. 4, in some embodiments, the packer member 162 is movable along a longitudinal direction (e.g., linearly, etc.) between a first position and a second position. In some embodiments, the packer member 162 is rotatably movable between the first position and the second position. In some embodiments, the movement of the packer member 162 may be movable between a first position and a second position by rotational movement and further movable to a third position by linear movement. In some embodiments, the movement of the packer member 162 may be movable between the first position and the second position by linear movement and further movable to a third position by rotational movement. In an exemplary embodiment, the first position is a ready position (as in FIG. 4) in which the packer member 162 is positioned to receive refuse, the third position is an eject position used to eject refuse and/or other material contained within the storage volume 150 out of the refuse compartment 130, and the second position is a packing position intermediate between the first and third positions.

Turning to FIGS. 5A, 5B, and 5C an exemplary embodiment of a packing member 500 is shown. The exemplary packing member includes a packing surface 505 configured to engage the refuse and/or other material during material loading and compacting operations. In an exemplary embodiment, the packing surface includes a first vertical portion 510, a sloped second portion 550, and third vertical portion 560 that are configured to efficiently engage with the refuse as it is packed. The relative sizes and the angles of the portions of the packing surface may be selected to ensure even distribution of forces as the packer member is pressed against the refuse. In this way, the forces on the packing member may be centered and rotational forces on the packer member may be avoided, reducing the stresses on the packer member components and on the actuators powering the packer member. Additionally, the exemplary packing member 500 includes at least one support member 512 to prevent torque on the packing member 500 due to uneven distribution of refuse or mass of refuse, which could cause rotational forces or stress in the packing member 500. Additionally, the packing member may include shoes 519 on the lower portion of the packing member, that slide along the floor or other surface and help the packing member resist bending and stress and maintain alignment within the refuse compartment.

The packing member 500 may include lateral reinforcement members that are configured to distribute loads uniformly across the vehicle body. The packing member may also include a cover 509 to prevent refuse from climbing the packing surface 505 of the packing member during operation and to prevent refuse and/or other material from falling into an area behind the packing member 500. The cover 509 may include brace arms 508 coupled with the packing member 500 to secure the cover 506 in place. In this way, fouling or ingression of material into the mechanisms and other components located behind the packing member 500, such as the actuators and accompanying motors and electronic controllers, may be avoided. The packing member 500 may made be made of one or more materials including high durability plastic and/or metal.

### Packer Assembly Actuation

The packer members of the above-described embodiments may be movable between a plurality of positions and may be actuated. The actuators to be used will generally depend on the motion needed, and any actuator or motor known in the art may be adopted to the needs of the devices. Specific possible methods and devices for actuating the packer members as described above is provided herein.

As an initial matter, as referred to herein, an “actuator” may refer to any component that is capable of performing the desired function. For any actuators coupled to or associated with the packer member 162, the desired function may refer to moving the packer member 162 relative to the hopper 140 and the storage volume 150 of the refuse compartment 130. As previously disclosed, the movement may be linear, rotational, or a combination of linear and rotation motions. For example, the term “actuator” as used herein may refer to electric actuators configured to be powered via electricity provided by an energy storage and/or generation system onboard the chassis, ball screw actuators (e.g., ball screws driven by an electric motor), linear actuators, hydraulic cylinders driven by an electronically driven hydraulic pump (e.g., driven by the electric motor, the secondary electric motor, etc.), a rack and a pinion driven by an electric motor, a winch system that is configured to cause rotation, a torsion spring that causes actuation, or various other actuators. In another example, the actuators are an electric pump that pressurize a hydraulic fluid and then drive, lift, or rotate the various components through hydraulic cylinders filled with the pressurized hydraulic fluid. In yet another example, the actuators are electric high force ball screw actuators that provide enough force to drive, lift, or rotate the various components.

Actuators 164 may extend or rotate to move the packer member 162 from the first position to the second position, or to move portions of the packer member toward the storage volume 150. Actuators 164 may extend or rotate to move the packer member 162 from either the first or second position to the third position, or to move portions of the packer member toward the rear of the storage volume 150, thereby substantially clearing the storage volume of refuse. The packer member actuator 164 may be one or more types of various actuators configured to facilitate linear and/or rotational movement of the packer member or portions thereof, as will be further described.

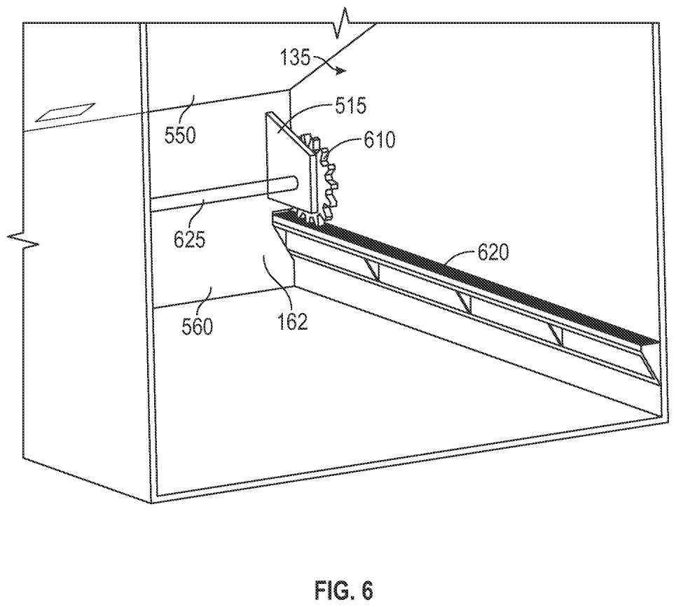

Referring to FIG. 6, the packer member 162 may be movable by at least one actuator between various positions within the refuse container. Only a portion of a packer member 162 is shown in FIG. 6, and the view is simplified, removing many of the other components to focus the attention on the manner of actuation of the packer member 162. In an exemplary embodiment, the packer member 162 may include a gear 610 (or other mechanical device) attached to a connecting rod 625, both of which are coupled to the packer member 162 by at least one support brace 515. The gear 610 is configured to interface with a track 620 secured to an internal wall 135 of the refuse container. In the exemplary embodiment shown in FIG. 6, the track 620 is provided by a lantern rack having vertically oriented rungs spaced apart along a longitudinal direction (e.g., parallel to the vehicle chassis), but other suitable track designs may also be used. The vertically oriented rungs may mitigate refuse ingestion by allowing waste and other material to pass through the gaps between rungs during operation. In some embodiments, a shear (e.g., a shear member, a debris removal member, etc.) is positioned on the front of the packer member 162 to shear off or otherwise remove any refuse that may become attached to the track or that otherwise may interfere or obstruct movement of the gear 610 interfacing with the track 620. In some embodiments, the gear 610 and track 620 are positioned within a channel (not shown) with a slot for connection to the rod 625, thereby reducing the amount of refuse that may foul the track.

The connecting rod 625 may be rotated by a power source (e.g., a motor), causing the gear 610 to rotate and interface with the track 620 producing lateral force on the packer member 162. The power source used may be an electrical or a combustion motor. The power source used may be a dedicated power source for the actuation of the packing assembly, or may also provide power to other systems in the operation of the refuse vehicle. The power source may be coupled to a controller that provides a user interface, allowing a user to control the operation of the packing assembly. In some embodiments, a single motor may be used, but in other embodiments multiple motors may be used. When multiple motors (e.g., two motors, one to power a gear or actuator on each lateral side of the packer member) are used, sensors may be used to provide feedback to a controller regarding the relative position of each side of the packer member 162. In this way, the controller may adjust the performance of the motors to prevent the packer member 162 from becoming skewed or otherwise misaligned within the refuse compartment. The motor or motors used may be positioned behind the packer member 162 or may be positioned within the refuse compartment or external to the refuse compartment. If within the refuse compartment, the motors may be placed such that they are above the expected liquid level within the compartment (e.g., due to leachate).

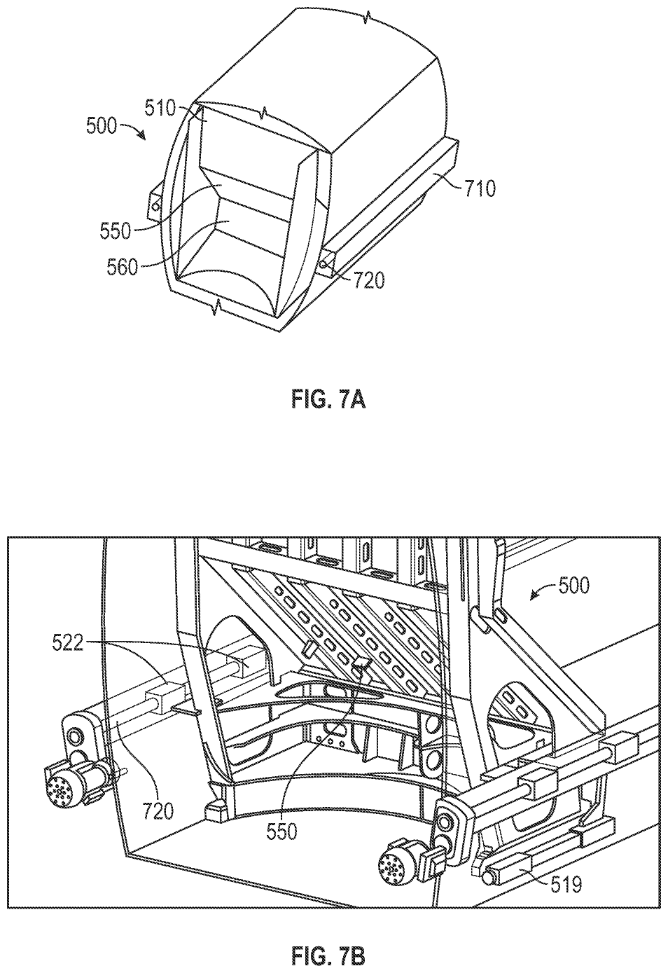

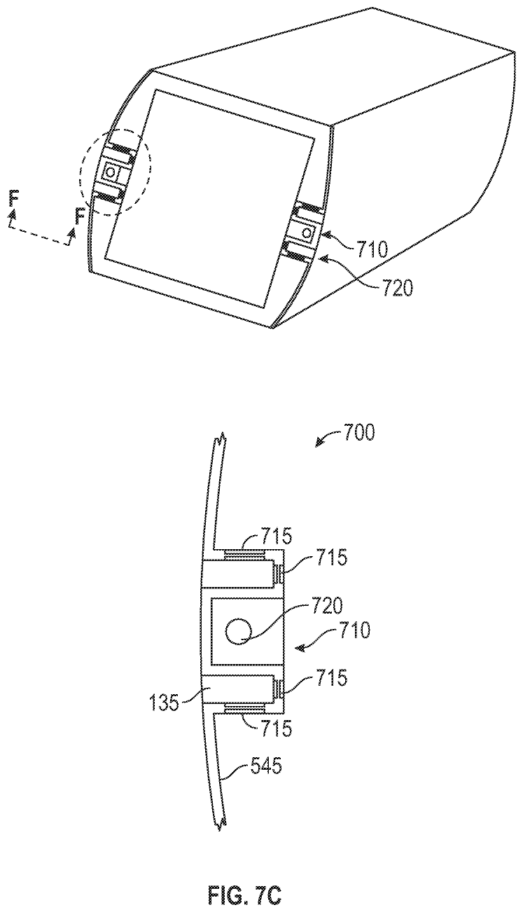

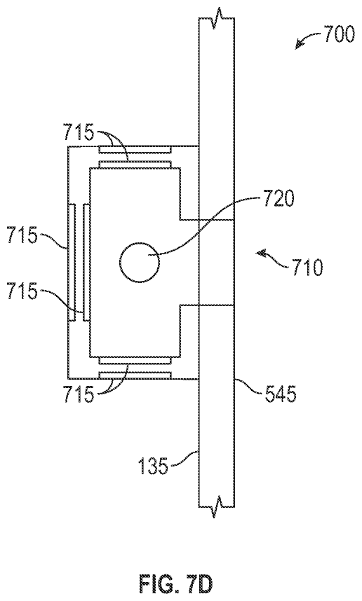

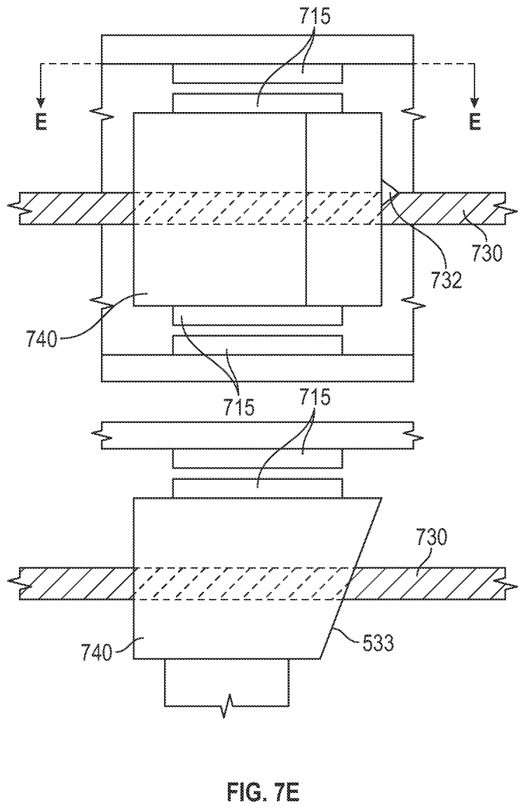

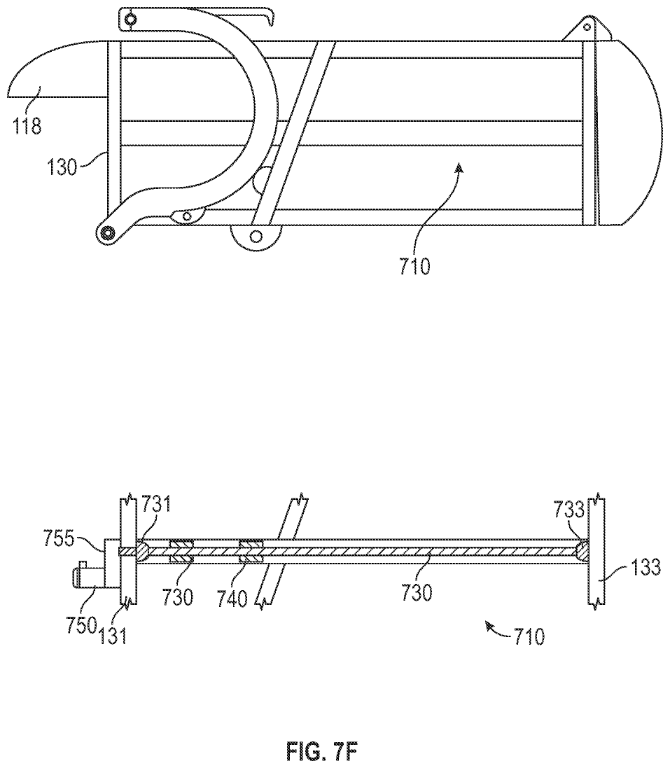

Turning FIGS. 7A-7E, in an exemplary embodiment, the packing assembly 160 may include a packer member 162 that is coupled to a ball screw assembly 700. The ball screw actuator assembly (e.g., a linear actuator assembly that translates rotational motion to linear motor) may include at least one ball screw 730 and a ball screw nut 740 rotatably coupled to the ball screw 730. The ball screw 730 may be contained within a channel extending along a sidewall of the vehicle body. The channel 710 may be oriented substantially parallel to the frame rails of the vehicle and may extend along substantially an entire length of the vehicle body. The channels 710 may at least partially surround the ball screw actuator assembly (e.g., on at least three sides of the ball screw actuator assembly, etc.) so as to protect the ball screw 730 contained within the channel from debris and other fouling during operation. The channel 710 may also serve as a track for the ball screw nut 740 and, in some embodiments, packer shoes 519 (e.g., packer and/or ejector guide shoes, etc.), as detailed below. In the exemplary embodiment in FIGS. 7A-7E, the ball screw assembly 700 includes two ball screws 730, each placed on an opposite side of the packer member 162. The encompassing channels 710 may be secured to a wall 135 of the refuse compartment 130, and may be located at a height on the wall 135 that is above the expected level of leachate within the compartment (e.g., spaced apart from a bottom wall of the vehicle body to prevent ingestion of liquids from materials within the refuse compartment, liquids of the refuse stream, water from rain exposure to the refuse, etc.). In this way, the ball screw actuator assembly can operate with reduced incidence of fouling by the leachate ingestion into the channel.

In one embodiment, as shown in FIGS. 7A, 7B, and 7D, the channels 710 and ball screws 730 may be located external to the refuse compartment, on an outer surface of a side wall 135 of the refuse compartment 130. Alternatively, the channels 710 and ball screws 730 may be located interior of the side wall 135, as shown in FIG. 7C. In such an embodiment, the screw nut 740 and shoes 519 may be formed into a pack and eject panel 545 that extends along the side wall 135 of the vehicle body and that defines at least one channel 710 for receiving guide shoes 519 therein (e.g., guide shoes 519 fixedly coupled to the side wall 135 and extending inwardly toward the refuse compartment, etc.).

With continued reference to FIGS. 7A-7E, the ball screw actuator assembly may also include a ball screw nut 740 located within the channel 710 and coupled to the packer member 162. The nut 740 may include teeth, grooves, or other structure (not shown) that threadingly couple with the grooves in the screw, such that rotation of the screw 730 will cause the nut 740 to move laterally along the screw 730. In some embodiments, the wall 135 may define a slot that opens the channel to the interior of the refuse compartment. The slot may be sized to accommodate a support structure between the packer member and the ball screw actuator assembly. A height of the slot may be less than a height of the nut 740 and/or the channel to prevent the nut 740 from passing through the slot and to prevent ingestion of materials from the refuse compartment into the channel. The slot may be disposed adjacent to a lower end of the nut 740 to allow refuse and/or other material to pass out of the channel and back into the refuse compartment during actuation. The nut 740 may be coupled to the packer member via a connection member that is positioned through the slot, such that rotation of the screw 730 will cause the packer member to move relative to the vehicle body. In some embodiments, as shown in FIG. 7E, the ejector guide shoe 519 may feature angled faces 533 that direct refuse that may enter the slot and encroach the channel back into the refuse compartment. For example, the ejector guide shoe 519 may have a forward and/or rear face that is tapered so that a length of the shoe 519 adjacent to an outer cover of the enclosure is greater than a length of the shoe 519 adjacent to the slot.

To reduce rotational forces on the packer member 500, a packer shoe 519 may also be placed adjacent to the ball screw nut 740. The packer shoe 519 may be a second ball screw nut 740 that is spaced apart from the ball screw nut 740 along a longitudinal direction. The packer shoe 519 and/or the ball screw nut 740 may be sized such that they closely fit within the channel 710 (e.g., so that the channel walls prevent rotation of the packer shoe 519 and/or ball screw nut 740 relative to the channel). The ball screw actuator assembly 700 may include a plurality of wear strips 715 located between the packer shoe and the interior walls of the screw channel 710 to reduce wear and tear on the screw ball actuator assembly 700. The wear strips 715 may function as a sacrificial surface and may be replaceable. The wear strips may be rubber, plastic, metal, or a combination thereof. The ball screw nut 740 and the packer shoe 519 may also include wear strips to reduce wear as these parts travel within the channel 710.

The ball screw 730 of the ball screw assembly 700 may be supported by a front and rear bearing 731, 733 which may be attached to a front and rear post 131, 133 of the refuse compartment (e.g., the ball screw may be secured, mounted, or otherwise anchored to both the headframe and the rear post of the refuse body, etc.). In this way, the forces associated with packing the refuse material can be effectively distributed to the frame of the refuse compartment. Some lateral and axial play may be allowed by the bearings 731, 733.

The ball screw actuator assembly 700 may be coupled to and receive power form a motor 750 via a gearbox 755. The motor 750 may be an electric motor configured to receive power from an onboard vehicle generator, or another onboard power supply (e.g., a battery, etc.). The gearbox may distribute power from the motor 750 to one ball screw 730. In the exemplary embodiment, the gearbox 755 distributes power from the motor 750 to both of the ball screws 730. In other embodiments, each ball screw 730 is powered by a separate motor 750. The ball screws in this way may be rotated at the same rate, reducing strain on the packing member. The ball screw assembly may include controls to time the movement of the two ball screws together and may also include sensors to provide feedback to a controller on the position of each of the ball screw nuts 740 to reduce strain on the packer member. The motor 750 may be electrical or it may be combustion powered. The motor can be dedicated to the movement of the packer member or it may also be used to provide power to other systems on the refuse vehicle. The gearbox may operate at a single speed or may operate at multiple speeds. In one embodiment, the gearbox has at least two speeds: 1) a first, slower speed for the high-pressure packing operations, and 2) a second, faster speed for the lower-pressure eject operations.

As shown in FIG. 7D specifically, the ball screw assembly 700 may include a scraper 732 (e.g., a scraper member, etc.) positioned adjacent where the ball screw enters the ball screw nut 740 or the packer shoe 519. In the exemplary embodiment, the scraper 732 is at least partially positioned within a groove of the ball screw 730. In this way, the scraper can remove debris, such as dust or refuse, that may become attached to the ball screw during operation, preventing the screw from jamming within the nut or shoe. A second scraper (not shown) may be disposed on the opposite side of the ball screw nut 740 or ejector guide shoe 519. The scraper 732 may alternatively be placed at any suitable location where it is able to remove debris and refuse from the screw as the nut 740 and ejector guide shoe 519 travel along the screw 730. Alternatively, a sheet steel cover or flexible bristles (not shown) may be positioned close to the screw or the slot opening to knock off any refuse from the ball screw during operation. Automatic lubrication and greasepoints are also contemplated for the ball screw actuator assembly 700 to ensure proper lubrication maintenance of the components of the assembly. For example, the enclosure for the actuator may include greasepoints and/or an automatic lubrication system coupled thereto to periodically introduce lubrication into the enclosure (e.g., into the channel containing the actuator) and to increase the service life of the actuator.

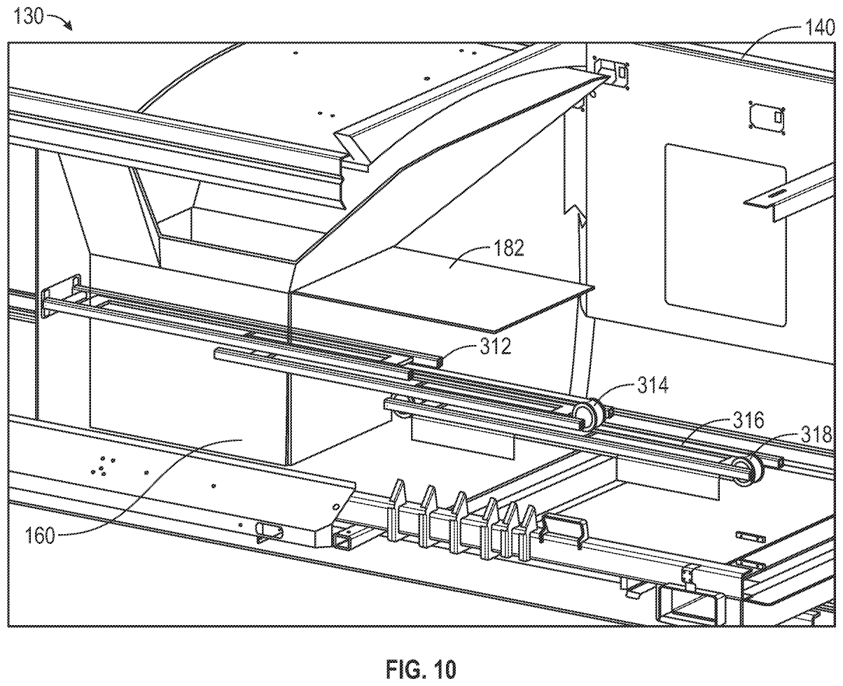

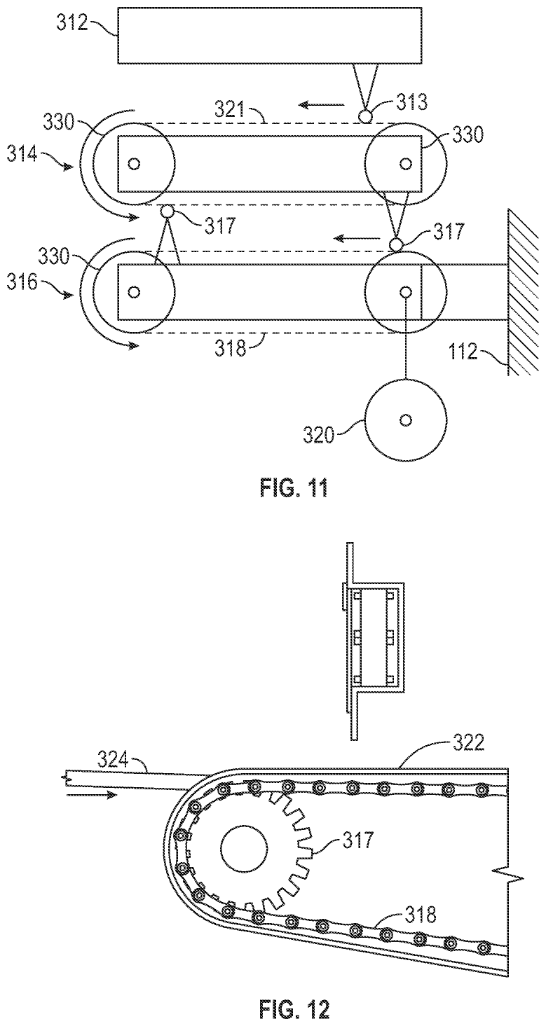

Turning now to FIGS. 10-12, an exemplary embodiment includes a telescopic chain drive 310 for moving the packer member 162 from a first ready position within the hopper volume 140 into the storage volume 150 of the refuse compartment 130. In the exemplary embodiment, the chain drive 310 includes a first sliding rail 312 and a second sliding rail 314 coupled to a third fixed rail 316 that is attached to or other fixed to the refuse compartment 130. For example the third fixed rail 316 may be attached to a wall 112 of the refuse compartment 130 via an anchor. The second and third rails 314, 316 have rotatable gears or sprockets 330 that guide the chains 318, 321 around the rails. A first sprocket 330 on the fixed rail 316 is attached to a motor 320, which provides rotational power to the first sprocket, which in turn drives the chains. Anchors 315, 317, 313 are coupled to the chains 318, 321 at selected locations such that, as the chains move around the respective rails 314, 316, the rails telescopically extend. As the first rail 312 is coupled to the packer member 162, the power of the telescoping rails is translated to the packer member, moving it toward the rear of storage volume 150 of the refuse compartment 130 as the sliding rails 312, 314 extend away from the fixed rail 316. The sliding rails 312, 314 may be retracted by reversing the direction of the rotation provided to the first sprocket 330 by the motor, thereby also retracting the coupled packer member 162.

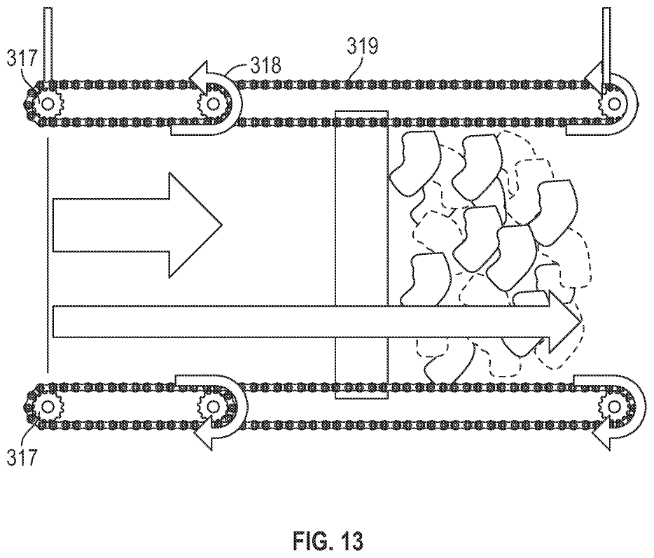

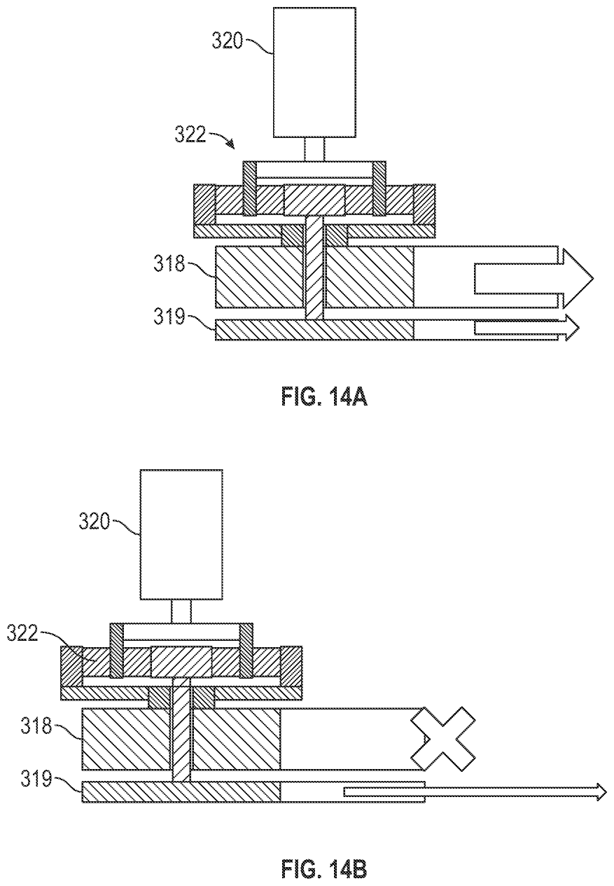

Turning to FIGS. 13, 14A, and 14B, the telescopic chain drive described above can employ chains of differing lengths to control the distance that the sliding rails 312, 314 extend. In the exemplary embodiment, two chain lengths are used, a first chain length that results in the rails extending sufficiently for the packer member 162 to move to a packing position (a packing conditions, i.e. a movement in which the packer member moves at least partially into the storage volume 150 of the refuse compartment 130, pushing refuse into the storage volume), and a second length that results in the rails extending sufficiently for the packer member to move to an eject position (an eject condition, i.e. a movement in which the packer member moves into the storage volume of the refuse compartment sufficiently to eject refuse from the storage area when the tail gate 134 is open). The packing condition involves moving and crushing the refuse contained within the storage volume 150 of the refuse compartment 130, while the ejection condition may require less force as the refuse it being pushed out of the compartment. For this reason, a high torque chain 318 may be employed for the packing condition and a lower torque chain may be employed for the eject condition. The length of chain that is engaged by the motor can be selected by any known technique in the art. In the exemplary embodiment, the selection is controlled through the use of a planetary differential. During a packing condition, both chains will be engaged by the motor through the differential. But during the eject condition, by adjusting the speed of the motor, the differential will direct the torque to the low torque eject chain, and the high torque packing chain will bottom out and fail to fully extend.

Turning back to FIG. 12 particularly, the telescoping chain system can be housed within a cover to protect it from refuse and leached liquids. A stainless steel or spring steel (or other suitable material) strip can but used to cover the chains prevent refuse from being caught in the chains as they move. A spring-loaded scraper 324 may be placed near the cover strip 322 to remove any refuse that becomes attached to the cover strip. In some embodiments, the cover strip 322 may be coupled to at least a portion of the chain or may be otherwise arranged to move with the chain during operation to shield the chain from materials within the refuse compartment.

### Rotatable Packer Member

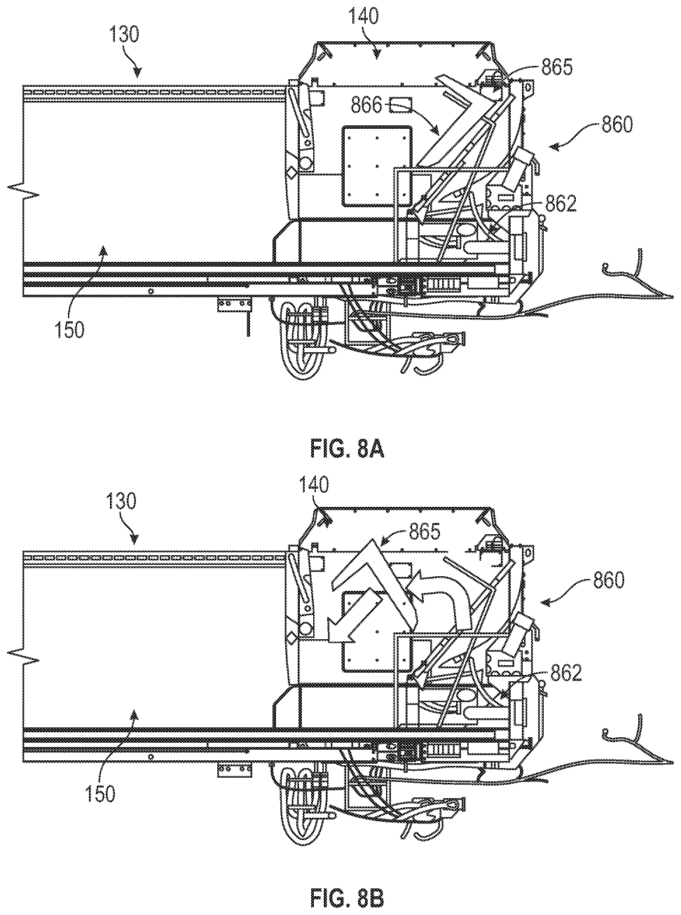

Turning to FIGS. 8A and 8B, in another exemplary embodiment, a refuse compartment 130 may have a packing member 860 including a main packer body 862 and at least one rotatable member 865 rotatably coupled to the main packer body. A plurality of rotatable members may also be included in the packing member 860.

With reference to FIG. 8A, the rotatable member may be maintained in a first ready position during loading of refuse into the hopper 140 of the refuse compartment 130. The rotatable member 865 may present an angled or sloped surface 866 for the refuse to contact as it is deposited into the hopper 140, directing the refuse into the storage volume 150 of the refuse compartment 130. As illustrated in FIG. 8B, the rotatable member 865 may be operated to rotate to a second packing position in which the rotatable member pushes refuse in the hopper 140 into the storage volume 150 of the refuse compartment 130. Actuators may provide power to the rotatable member 865 to power the rotation of the member. The main packer body 862 may be movable from a ready position to a packing position and to an eject position as previously described. Actuators may extend or rotate to move the main packer body 860 from either the first or second position to the third position, or to move portions of the main packer body toward the rear of the storage volume 150, thereby substantially clearing the storage volume of refuse. The main packer body actuator may be one or more types of various actuators configured to facilitate linear and/or rotational movement of the main packer body or portions thereof.

The rotatable packer of the above-described embodiments may be movable between a plurality of positions and may be actuated. The actuators to be used will generally depend on the motion needed, and any actuator or motor known in the art may be adopted to the needs of the devices. The actuators that power the rotation of the rotatable member 865 may be the same as the actuators that power the movement of the main packer body, or the actuators may be dedicated to the rotation of the rotatable packer member.

### Sweep Packer

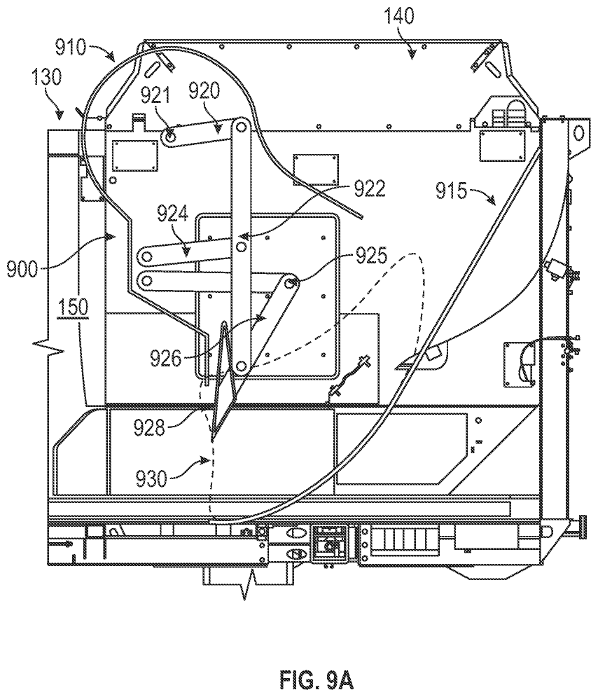

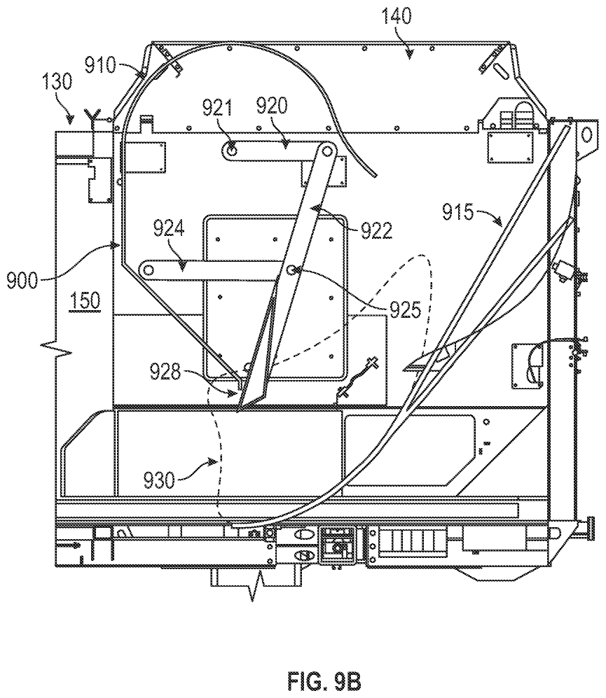

Turning to FIGS. 9A and 9B, a refuse vehicle may include a sweep assembly 900 for packing the refuse from the hopper 140 of a refuse compartment into a storage volume 150. In an exemplary embodiment, as in FIG. 9A, the sweep assembly 900 may include a rotatable arm 920 coupled with a rotating pin 921. The rotatable arm may be rotatably coupled to a transverse arm 922, which is itself actuatably coupled to at least one support arm 924. At least one of the at least one support arms 924 and the transverse arms may be articulably coupled to a sweep arm 926 that includes a sweep surface on one end 928. The sweep assembly 900 is configured to actuate the sweep surface 928 in response to rotation of the rotatable arm 920, thereby defining a sweep volume 930. A sloped surface 915 may direct refuse deposited into the hopper 140 of the refuse compartment 130 toward the bottom of the hopper where it will be compacted by the sweep surface 928 of the sweep assembly 900 and pushed toward the storage volume 150 during operation of the sweep assembly. While a single rotatable arm, support arm, transverse arm, and sweep arm are illustrated, multiple arms may be employed in a spaced relation across the width of the hopper 140.

In an exemplary embodiment, as in FIG. 9B, the sweep assembly 900 may include a rotatable arm 920 coupled with a rotating pin 921. The rotatable arm may be rotatably coupled to a transverse arm 922, which is itself actuatably coupled a sweep arm 924. One end of the sweep arm includes a sweep surface 928. The sweep assembly 900 is configured to actuate the sweep surface 928 in response to rotation of the rotatable arm 920, thereby defining a sweep volume 930. A sloped surface 915 may direct refuse deposited into the hopper 140 of the refuse compartment 130 toward the bottom of the hopper where it will be compacted by the sweep surface 928 of the sweep assembly 900 and pushed toward the storage volume 150 during operation of the sweep assembly. While a single rotatable arm, support arm, and sweep arm are illustrated, multiple arms may be employed in a spaced relation across the width of the hopper 140.

The rotatable packer of the above-described embodiments may be movable between a plurality of positions and may be actuated. The actuators to be used will generally depend on the motion needed, and any actuator or motor known in the art may be adopted to the needs of the devices. The actuators that power the rotation of the rotatable member 865 may be the same as the actuators that power the movement of the main packer body, or the actuators may be dedicated to the rotation of the rotatable packer member.

The rotatable arm may be actuated by a power source (e.g., a motor, a battery, etc.). The sweep assembly 900 may include a gearbox or differential (not shown) to control the speed of the rotation of the rotatable arm 920. The power source for the actuation of the sweep assembly 900 may be dedicated to the sweep assembly, or may alternatively be used to also power other devices and functions of the refuse vehicle. For example, the actuator coupled to the rotatable arm 920 may be powered by the electrical current provided by a battery or by an alternator driven by the engine of the refuse vehicle.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or movable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X; Y; Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the refuse vehicle 110 and the subhopper 162, and the systems and components thereof, as shown in the various exemplary embodiments is illustrative only. Additionally, any element disclosed in one embodiment may be incorporated or utilized with any other embodiment disclosed herein.

1. A refuse vehicle comprising:
a chassis;
a cab coupled to the chassis;
a refuse body coupled to the chassis and defining a refuse compartment; and
a packer assembly comprising:
a packer body disposed within the refuse compartment; and
an actuator coupled to the packer body and configured to move the packer body within the refuse compartment; and
an enclosure that extends along the refuse body parallel to the chassis, the enclosure at least partially separating the at least one actuator from the refuse compartment.

2. The refuse vehicle of claim 1, wherein the actuator is spaced apart from a lower wall of the refuse body to be above a liquid level of the refuse stream within the refuse compartment.

3. The refuse vehicle of claim 1, wherein the at least one actuator is a ball screw actuator.

4. The refuse vehicle of claim 3, wherein the ball screw actuator includes a ball screw and a scraper positioned at least partially within a groove of the ball screw to remove refuse from the ball screw during operation of the ball screw actuator.

5. The refuse vehicle of claim 1, wherein the enclosure is disposed outside of the refuse compartment.

6. The refuse vehicle of claim 5, wherein the actuator comprises a guide shoe disposed within the enclosure and coupled to the packer body, the channel directing movement of the guide shoe along a length of the refuse body.

7. The refuse vehicle of claim 1, wherein a sidewall of the refuse body defines an elongated slot that extends in a longitudinal direction along the refuse body, the slot connecting the enclosure to the refuse compartment.

8. The refuse vehicle of claim 7, wherein the enclosure defines a longitudinally extending channel, and wherein a height of the slot is less than a height of the channel.

9. The refuse vehicle of claim 1, wherein the enclosure is coupled to an outer surface of a sidewall of the refuse body, the enclosure defining a first channel along a first side of the refuse body, wherein the actuator is disposed within the enclosure.

10. The refuse vehicle of claim 1 wherein the packer body comprises at least one sloped surface and at least one surface that is substantially vertical.

11. The refuse vehicle of claim 1, wherein the packer body is movable between a first ready position and a second packing position by rotation of the packer body, linear movement of the packer body, or a combination of rotation and linear movement of the packer body.

12. The refuse vehicle of claim 11, wherein the packer body is movable between a first ready position and a third eject position by rotation of the packer body, linear movement of the packer body, or a combination of rotation and linear movement of the packer body.

13. The refuse vehicle of claim 1, wherein the at least one actuator comprises a first actuator and a second actuator, the first actuator and the second actuator being ball screw actuators.

14. A packer assembly comprising:
a packer body configured to be disposed within a refuse compartment of a refuse vehicle; and
an actuator coupled to the packer body and configured to move the packer body within the refuse compartment; and
an enclosure that extends along the refuse body parallel to the chassis, the enclosure at least partially separating the at least one actuator from the refuse compartment.

15. The packer assembly of claim 14, wherein the at least one actuator is a ball screw actuator.

16. The packer assembly of claim 15, wherein the ball screw actuator includes a ball screw and a scraper positioned at least partially within a groove of the ball screw to remove refuse from the ball screw during operation of the ball screw actuator.

17. The packer assembly of claim 14 wherein the packer body comprises at least one sloped surface and at least one surface that is substantially vertical.

18. The packer assembly of claim 17, wherein the packer body further comprises a lateral reinforcement member configured to prevent rotation of the packing member in operation or a cover configured to prevent refuse from falling behind the packing member in operation.

19. A packer body configured to be disposed within a refuse compartment of a refuse vehicle, the packer body comprising:
a first refuse contact surface that is substantially vertical;
a second surface congruent with the first surface, the second surface angled with respect to the first surface;
and a third surface that is substantially vertical, the third surface congruent with the second surface.

20. The packer body of claim 19, further comprising a lateral reinforcement member configured to prevent rotation of the packing member in operation and a cover configured to prevent refuse from falling behind the packing member in operation.
